(19) United States
(12) Patent Application Publication
(10) Pub. No.: US 2005/0153716 A1
(43) Pub. Date: Jul. 14, 2005

(54) Wireless, multi-user audio system

(76) Inventor: Martin Reed Bodley, Sudbury, MA (US)

Correspondence Address: Brian M. Dingman, Esq.;Mirick, O'Connell, Demallie & Lougee, LLP, 1700 West Park Drive, Westborough, MA, 01581, US

(21) Appl. No.: 11/032,690

(22) Filed: Jan. 10, 2005

Related U.S. Application Data
(60) Provisional application No. 60/535,439, filed on Jan. 9, 2004.

(51) Int. Cl. H04B 1/38; H04H 5/00; H04Q 7/20

(52) U.S. Cl. 455/463; 381/2; 381/16; 455/557; 455/555

(57) ABSTRACT

A wireless audio system for a number of users. The system includes a base unit that is adapted to removably store, recharge and communicate with personal microphone modules. The system also includes a plurality of personal microphone modules that each are adapted to be removably coupled to a user's clothing, and to communicate wirelessly with the base unit.

### CROSS REFERENCE TO RELATED APPLICATION

This application claims priority of Provisional application Ser. No. 60/535,439, filed on Jan. 9, 2004.

### FIELD OF THE INVENTION

This invention relates to audio systems for remote telecommunications-based conferencing.

### BACKGROUND OF THE INVENTION

Audio teleconferencing has grown in popularity. Commonly, the audio systems use a tabletop microphone. The users must thus always be relatively close to the microphone, and also must always be aware of the direction in which they are speaking. Such systems thus intrude on the meeting. In addition, as the microphones are omni-directional and located on the tabletop, they pick up and transmit to the remote participants undesirable ambient noise. Common sources of unwanted ambient noise include table noise, sidebar conversations, laptop keyboard clicks, coffee cup clinks, etc. These ‘unwanted’ audio sources are very damaging to the efficiency, focus and productivity of conference meetings, especially for far-end (remote) participants in the conference.

### SUMMARY OF THE INVENTION

This invention features a novel wireless microphone system, which enables optimal audio input from one or more parties actively participating in audio conferencing, (telephony, video, net meetings) or voice recording applications.

The system includes a clip-on personal microphone module (PMM). One or more PMMs communicate with a base station, which in the preferred embodiment can support up to 12 individual PMMs. The base station performs audio mixing and automatic gain control from all registered PMMs, PMM battery charging, and connectivity to audio patch panels or other conferencing equipment. The users remove a PMM from the holder/charger when they enter a conference call, clip the PMM onto their shirt pocket or lapel, and return the PMM to the holder when they are done.

By using discrete and wireless PMMs, located near each speaker's mouth, the system provides superior audio quality for those participants on the far-end of the conference. This is further accomplished through a combination of audio processing and the optimal positioning of the directional microphone within the PMM, which attenuates and filters ambient noise before mixing with the outgoing audio signal. Additionally, the sound quality provided by this system is ideally suited for recording purposes.

RF wireless transceivers built into each PMM enable all users to operate freely during the meeting without being tethered to wires or requiring line-of-sight to the base station. Users can even leave the room, and still participate in the call, as a plug-in ear bud allows the user to hear the received audio that is transmitted by the base station. A mute button located on the PMM allows users to cough/sneeze or have offline conversations without distracting the meeting. With a PMM, the user will forget about the microphone and focus on the discussion, unlike when the users employ headsets or table-top microphones.

The system also includes a base station that provides wireless gateway and audio multiplexing along with the connectivity required to interface with existing audio equipment located in the conference room. Two types of base units are provided for:

(1) Rack mount for installation within an existing AN system rack in a high end A/V type room. With this type of base, the PMMs typically are stored in a separate holder/charger base unit that can be located anywhere in the room.

(2) Tabletop, which will integrate the wireless hub and PMM holder/charging station functions in a stylish form factor.

This invention features a wireless audio system for a number of users, comprising a base unit that is adapted to removably store, recharge and communicate with personal microphone modules (PMMs), and a plurality of PMMs that each comprise a microphone and are adapted to be removably coupled to a user's clothing, and to communicate wirelessly with the base unit. Each PMM may further comprise a mutable microphone, which may have a microphone mute-status indicator. The microphone mute-status indicator may comprise an indicator light carried by the PMM. Each PMM may further comprise a user-operable switch to control microphone muting. The wireless link may be automatically established between a PMM and the base unit when the PMM is removed from the base unit. Each PMM may further comprise a mutable microphone, and wherein the microphone is automatically muted when the PMM is removed from the base unit. The wireless link may be automatically terminated when the PMM that had been removed from the base unit is returned to the base unit.

A PMM may be uniquely registered with the base unit when the PMM is placed into the base unit. A PMM may be inactivated once it has been inactive for a predetermined time period. The predetermined time period may be user-adjustable. A PMM may be inactivated once it leaves an active distance range from the base unit. The active distance range may be user-adjustable. The base unit may further comprise a user-operable active distance range adjustment. An inactivated PMM may be reactivated once it is returned to within the active distance range of the base unit. The PMM may provide a human-perceptible indicator when it leaves the active distance range.

The base unit may further comprise a user-operable switch that is operable to mute all PMMs. The PMM muting may be accomplished by blocking the signals from the PMMs. The base unit may further comprise a user-operable switch that is operable to clear the registration of all PMMs registered with the base unit.

The wireless audio system may further comprise a video system comprising a motorized camera, six degree of freedom motion sensing equipment carried on a user's person, and a device for moving the camera in response to the user's location, to capture the user's image with the camera.

### BRIEF DESCRIPTION OF THE DRAWINGS

Other objects, features and advantages will occur to those skilled in the art from the following description of preferred embodiments and the accompanying drawings, in which:

FIGS. 1A and 1B are drawings of the preferred physical characteristics, and FIG. 1C is a functional block diagram, of one preferred embodiment of a PMM for the invention;

FIG. 2A is a drawing of the preferred physical characteristics, and FIG. 2B is a functional block diagram, of a preferred embodiment of a rack mounted integrated base/gateway unit for the invention;

FIG. 3A is a drawing of the preferred physical characteristics, and FIG. 3B is a functional block diagram, of a preferred embodiment of a PMM charging base for the invention;

FIG. 4A is a drawing of the preferred physical characteristics, and FIG. 4B is a functional block diagram, of a preferred embodiment of an integrated base/gateway/charger for the invention;

FIG. 5 is a state diagram of a preferred embodiment of the PMM for the invention;

FIG. 6 is state diagram of a preferred embodiment of the base unit for the invention; and

FIG. 7 is a simplified schematic diagram of a system of this invention which also includes video tracking of users.

### DETAILED DESCRIPTION OF THE PREFERRED EMBODIMENTS OF THE INVENTION

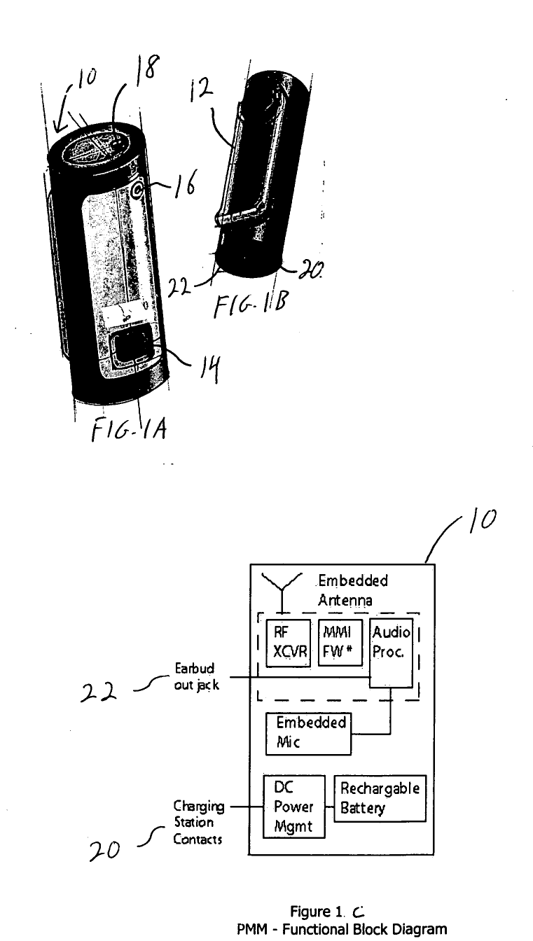

PMM 10 Performance/Feature Set (see FIGS. 1A and 1B):

Highly directional microphone with audio processing

Secure and reliable RF performance

Extended battery life through smart power management

Compact size and light weight

System software/MMI (Machine Man Interface)—simple to use, sophisticated performance results

Contacts 20 for recharging of battery

Ear bud audio out jack 22 allows the user to hear the mixed audio when out of hearing range of the room speaker (if one is used).

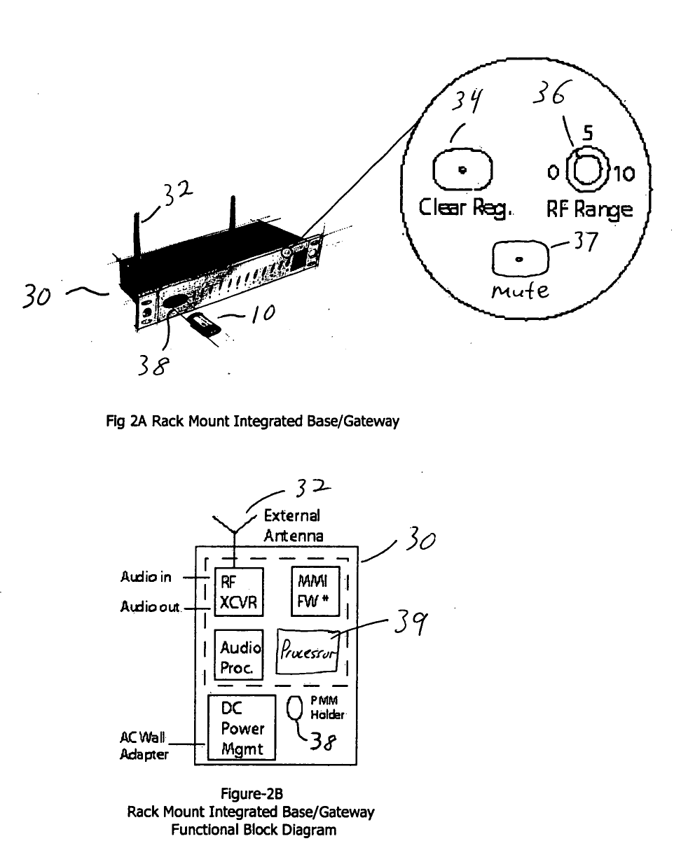

Base Unit 30, 50, 60 Performance/Feature-Set (see FIGS. 2A and 2B, 3A and 3B, and 4A and 4B):

Standard audio interface

Automatic audio mixing and gain control

Secure and reliable RF performance

System software/MMI—simple to use, sophisticated performance results

Modular: ability to add base units with more PMMs, to increase the number of users per room.

Properly achieving the performance and feature-set of the PMM are important to obtaining the most benefit to an audio conference. The directionality of the microphone acoustics rejects sound coming from below or either side of the user. PMM 10 has a clip 12 that allows it to be carried by clothing (e.g. a shirt pocket, neck tie or lapel) that places the microphone input 18 in close proximity to the speaker's mouth, which minimizes general background noise as well as cross talk between people in the room. Physical dimensions and ergonomics assist in positioning the PMM at the optimum location close to the user's mouth. Typical locations include shirt pockets, lapels or button seams. Lanyards can also be used if no suitable clipping feature is available on clothing. Radio performance allows farther ranging capability and longer talk times. A visual indicator 16 (e.g. one or more LEDs) conveys radio-link/charging status of each PMM 10.

Base unit features are important in achieving a system that is simple to setup and use with any existing A/V equipment. The use of industry standard connectors, audio levels, and naming conventions simplifies integration into existing installations. The base unit automatically adjusts for any PMM installed into any docking port 38, 68 of the base unit (i.e. the PMMs are hot swappable). The base unit handles all of the audio multiplexing and gain adjustments, such that all PMM audio levels are equal prior to being combined and presented at the audio connector.

The form factor and styling of the base unit is important to how the device will be used, where it is located in the room, and how readily the PMMs can be made available to users. Preferably, the base unit is designed such that it can be located in the middle of a table, on a credenza or mounted on a wall.

Ease of setup, use and operational status are driven by the proper design and implementation of the system operating software. The system is designed such that the operation of LED's and buttons provide visual and tactile status in an intuitive manner. Audio processing and handling are important to far-end performance results. Examples include: combining of audio channels, gain control, echo-cancellation. Smart power management of the PMMs allows increased battery life by using low power modes when possible.

The following are operational features of the preferred embodiments of PMM and the Base Unit.

PMM Features:

1. PMM automatically links to base by RF whenever removed from charger. If the PMM is “registered” with the base, a base audio channel is assigned to the PMM.

2. PMM automatically mutes the microphone when removed from the charging base, with the mute status indicated via PMM LED 16 (e.g. flashing red). This allows users to ‘silently’ attach the PMM before going live with their audio. Once the PMM is in place, the user will activate their audio by pressing the mute/unmute button 14, and the LED will indicate ‘live audio’ by flashing another color (e.g. blue or green).

3. PMM automatically shuts down RF link whenever inserted into base. Recharging begins, with recharge status indicated by PMM LED. The PMM unit registration is also updated when it is inserted into the base.

4. PMM automatically enters ‘power save’ mode after long periods of inactivity. This can be accomplished when there is no mic signal, no state change and/or no motion for a set time period. For example, a general purpose I/O pin on the PMM's main processor could be driven by an analog detection circuit that provide digital high and low conditions based on a threshold level of audio input on the PMM microphone line (ex. 1-2 mV rms). A timer would be started when no audio was detected, and once the timer reached a ‘time-out’ period (ex. 15 minutes) then the PMM would initiate a low-power state, removing the wireless link. The PMM would then wake up when placed into the charger base unit or when the mute button was pressed. This feature prevents the PMM from running out of battery when left on the table and not returned to the charger after a conference. Alternatively, during this mode the microphone can be monitored by the base unit with which it is registered, and the PMM returned to ‘active’ mode by the base unit when the PMM microphone outputs an audio signal above the threshold level.

5. PMM vibrates and/or beeps when the user leaves the range of the base unit, and the mic is automatically muted and the PMM enters the ‘inactive’ mode in which the PMM audio output is monitored. This prevents users from wearing a PMM back to their office or home.

6. PMM can employ 128-bit encryption on digital audio data, as well as RF power limiting (PMM radiates less power when closer to the base unit), advance spread spectrum and frequency hopping techniques, all ensuring maximum security.

7. PMM registers with base at contact with the base, allowing the PMMs to be ‘hot swappable’ between base units, thus allowing administrators greater flexibility in configuring their systems.

Base Unit Features:

1. ‘Mute’ button 37 that concurrently mutes/unmutes audio for all active PMMs; the current status is indicated with LEDs on all PMMs and on the base unit.

2. Automatic assignment of next available audio channel to an unregistered PMM (preferably, there are 12 channels allowed per base, but that is a convenience issue, not a design issue) when it is placed into the ‘Register Port’ on the base. Successful registration will be indicated via PMM LED (e.g. 5 rapid flashes).

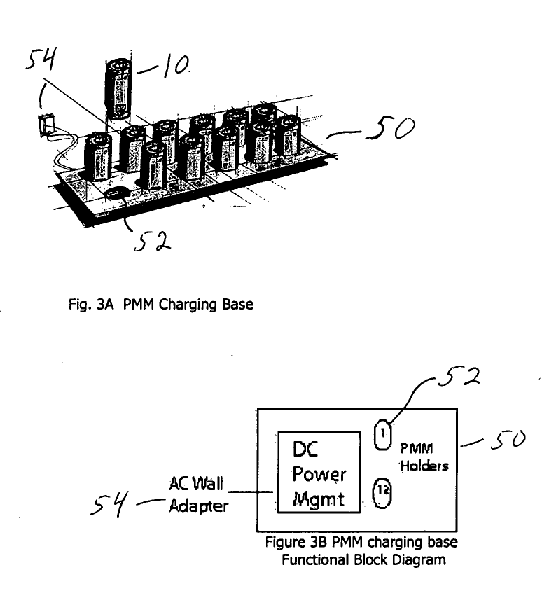

3. Rack-mount base unit (FIGS. 2A and 2B): audio ports for each individual PMM channel (up to 12) as well as a ‘conferenced’ audio port which combines all PMM channels together intelligently using automatic gain control, microphone voice switching, and mix/minus techniques. The single PMM holder 38 on this unit provides PMM registration capabilities. When this unit is used in place of an integrated Base/Gateway/Charger, the charging base 50 shown in FIGS. 3A and 3B would be used to hold and recharge the PMMs when they are not in use.

4. ‘Clear Registration’ button 34, 62, (located on integrated Base/Gateway units 30, 60). When pressed, the pairing information between base and all PMMs is cleared. This way only PMMs that register for a particular call will be active. This is an optional security feature.

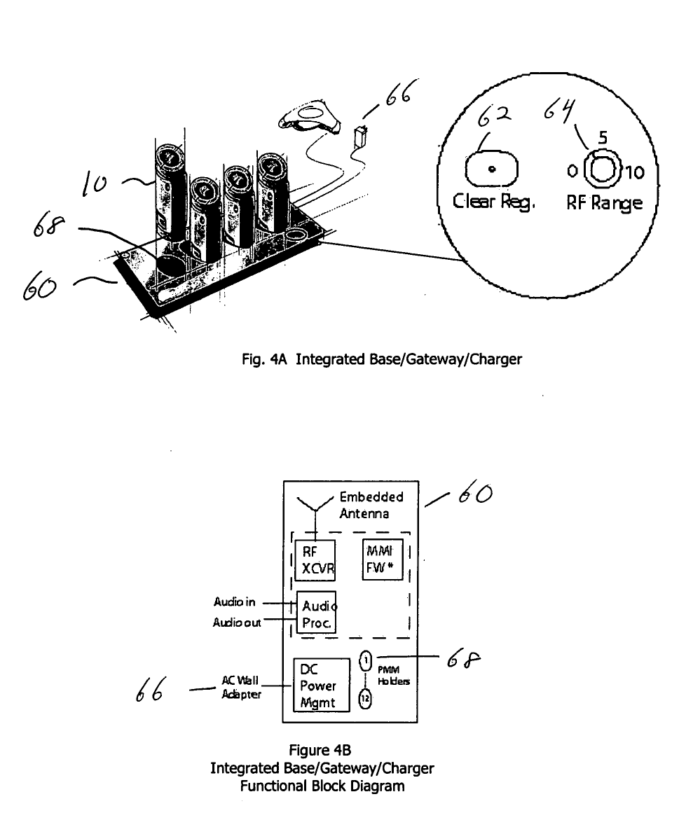

5. A ‘register port’ 52 can be included in the charging-only base 50, or the integrated base 60 shown in FIGS. 4A and 4B. In the charge-only base unit, a radio link would then enable PMM registration with the rack-mount base unit.

6. A ‘range-control’ knob 36, 64 at the base allows the system administrator to limit the RF operational range between the base and all registered PMMs. In one embodiment, the range can be set from 30 ft. to 300 ft. This can be accomplished by setting a PMM transmit power or a base unit received signal strength threshold. This is a security feature as well as a power-saving feature.

7. Additional processing 39, FIG. 2B, can be included in any of the base units for this invention. Processor 39 can be used for back-end audio processing such as speech recognition, automatic transcription processing, and data mining, for example.

8. The base unit functionality could be built directly in to a speaker phone or a videoconferencing unit, rather than be accomplished as a stand-alone device. This integration would allow the base unit to also perform the functions of a traditional speaker phone/videoconferencing unit when the wireless conferencing aspect is not necessary.

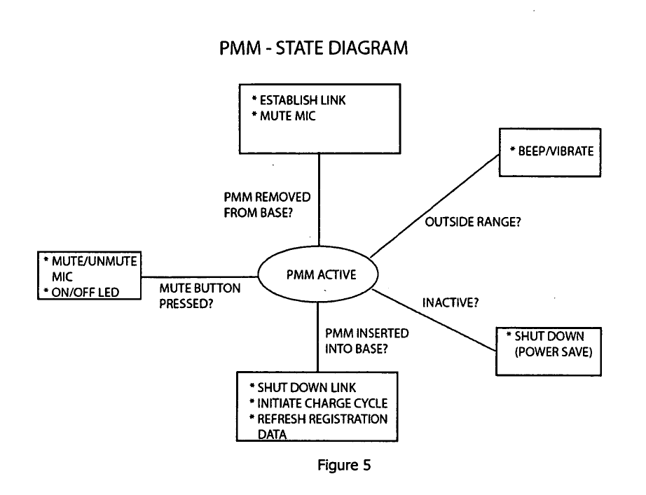

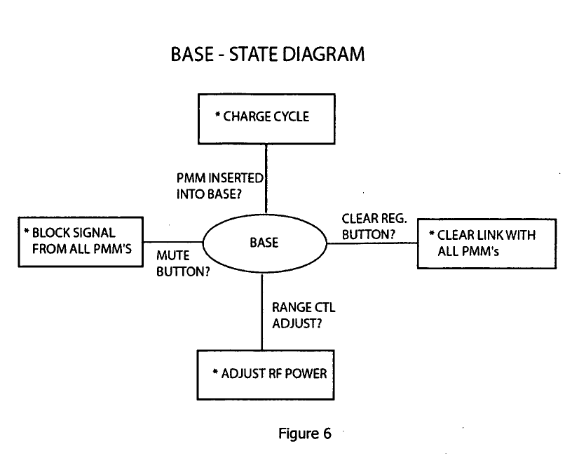

The functionality described above is accomplished through custom firmware that controls audio processing, power management and the RF transceiver functions. Additionally, all LED indicators and functionality of user interfaces are controlled through this combination of embedded firmware and processors. FIG. 5 ‘PMM—STATE DIAGRAM’ and FIG. 6, ‘BASE—STATE DIAGRAM’ disclose further functional and operational details.

The ability to provide a modular system hardware architecture allows customers to buy only the correct number of PMMs for the room they are equipping. As an example: a primary base unit can have all the power, audio and MMI interfaces, as well as, for example, 4 PMMs. The customer can then buy an extension base with 4 PMMs that attaches through a connector to the primary, and will automatically connect audio, power, etc., from the primary base. The extension base will not require full interface connections, power supply or base radio chipset. The PMMs in the extension bases will link up to the radio in the primary base. Two or more extension bases could be added to a primary base, allowing for additional PMMs to be available to the room.

Selection of the proper radio architecture/standard is important to obtaining the expandability/modularity, full duplex audio capabilities, total number of PMMs, power management, range, small size and cost to manufacture. Being able to secure country approval to use the product ‘globally’ requires operational frequencies within particular ISM bands. For these reasons, the DECT radio standard and associated chipsets that are commonly used in mobile & cordless phone systems are ideal for use in the invention. Being able to provide wide-band audio over the radio link is desirable but would require a derivative to the DECT standard chipsets be developed.

Variations on the base/microphone could be made available containing other types of wireless microphones. Examples include: wireless tabletop sector microphones for conference with re-configurable tables, wireless handheld microphones for auditoriums and roaming interviewers and headsets.

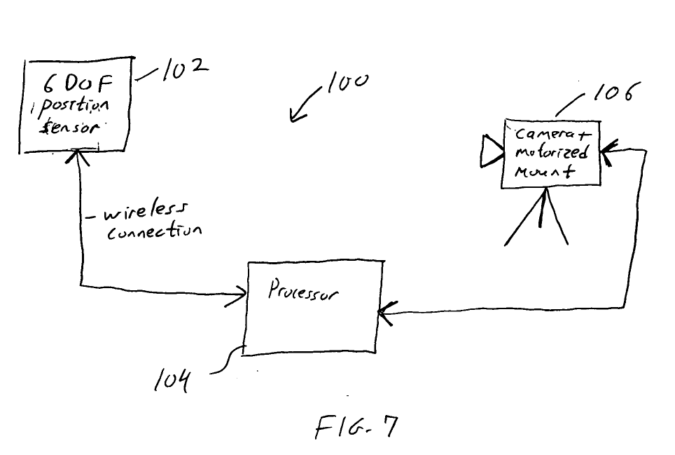

This system can also be expanded to achieve video conferencing. A standard video conferencing system could be used but with the wireless audio system disclosed herein. Alternatively, the invention can include video conferencing in which the speaker is automatically tracked by a video camera. A simplified schematic diagram of one embodiment of such an automatic video tracking scheme is shown in FIG. 7. Video camera and motorized camera mount 106 is controlled by processor 104 that is in wireless communication with user position sensor 102. Preferably, position sensor 102 is a six degree of freedom tracking system such as are known in the field. Examples of six degree of freedom tracking systems are available from InterSense, Bedford, Mass. Tracker 102 provides information establishing the position in space of the person carrying a PMM. Location information from the one or more position sensors 102 is interpreted by processor 104, which sends appropriate drive signals to motorized camera 106 so that the camera is moved as necessary to keep the speaker framed by the camera. The six degree of freedom position sensing system could be integrated into the PMMs or accomplished separately and then carried on the user's person.

Tracking capability can be implemented for multiple PMM's by having the user press a function button on the PMM when the user is ready to talk, or otherwise when the user desires to be tracked by the camera. The camera position would then be controlled in response to function button presses received by the base unit. There could also be another version of an ‘automatic’ mode to track multiple PMM's, where the microphone audio levels would trigger the camera to go to the highest level of incoming audio (presumably the person speaking. If more than one person begins talking at the same time, the camera system would stay on the current PMM until there is only one person talking, then move to that person. There would be minimum time gates applied to avoid having the camera move when somebody coughs or makes a brief comment but doesn't need to be on camera. The inventive system can be adapted to be remotely controlled, accessed and/or updated through the use of a network interface in the base station (e.g. using Ethernet, IP or wireless IP).

The primary implementation of this system is targeted at the audio/video conference call market. Other applications include, but are not limited to, medical/legal dictation. In this application the audio track is securely transmitted and captured electronically for future reference, archival purposes and/or to meet legal requirements.

Although specific features of the invention are shown in some drawings and not others, this is for convenience, as the various features may be combined in other manners in accordance with the claimed invention.

Other embodiments will occur to those skilled in the art and are within the following claims.

1. A wireless audio system for a number of users, comprising:
a base unit that is adapted to removably store, recharge and communicate with personal microphone modules (PMMs); and
a plurality of PMMs that each comprise a microphone and are adapted to be removably coupled to a user's clothing, and to communicate wirelessly with the base unit.

2. The wireless audio system of claim 1, wherein each PMM further comprises a mutable microphone.

3. The wireless audio system of claim 2, wherein each PMM further comprises a microphone mute-status indicator.

4. The wireless audio system of claim 3, wherein the microphone mute-status indicator comprises an indicator light carried by the PMM.

5. The wireless audio system of claim 2, wherein each PMM further comprises a user-operable switch to control microphone muting.

6. The wireless audio system of claim 1, wherein a wireless link is automatically established between a PMM and the base unit when the PMM is removed from the base unit.

7. The wireless audio system of claim 6, wherein each PMM further comprises a mutable microphone, and wherein the microphone is automatically muted when the PMM is removed from the base unit.

8. The wireless audio system of claim 6, wherein the wireless link is automatically terminated when the PMM that had been removed from the base unit is returned to the base unit.

9. The wireless audio system of claim 1, wherein a PMM is uniquely registered with the base unit when the PMM is placed into the base unit.

10. The wireless audio system of claim 1, wherein a PMM is inactivated once it has been inactive for a predetermined time period.

11. The wireless audio system of claim 10, wherein the predetermined time period is user-adjustable.

12. The wireless audio system of claim 1, wherein a PMM is inactivated once it leaves an active distance range from the base unit.

13. The wireless audio system of claim 12, wherein the active distance range is user-adjustable.

14. The wireless audio system of claim 13, wherein the base unit further comprises a user-operable active distance range adjustment.

15. The wireless audio system of claim 12, wherein an inactivated PMM is reactivated once it is returned to within the active distance range of the base unit.

16. The wireless audio system of claim 12, wherein the PMM provides a human-perceptible indicator when it leaves the active distance range.

17. The wireless audio system of claim 1, wherein the base unit further comprises a user-operable switch that is operable to mute all PMMs.

18. The wireless audio system of claim 17, wherein the PMM muting is accomplished by blocking the signals from the PMMs.

19. The wireless audio system of claim 9, wherein the base unit further comprises a user-operable switch that is operable to clear the registration of all PMMs registered with the base unit.

20. The wireless audio system of claim 1, further comprising a video system comprising a motorized camera, six degree of freedom motion sensing equipment carried on a user's person, and a device for moving the camera in response to the user's location, to capture the user's image with the camera.

21. A wireless audio system for a number of users, comprising:
a base unit that is adapted to removably store, recharge and communicate with personal microphone modules (PMMs); and
a plurality of PMMs that each comprise a mutable microphone and a microphone mute-status indicator, and are adapted to be removably coupled to a user's clothing, and to communicate wirelessly with the base unit;
wherein a wireless link is automatically established between a PMM and the base unit, and the PMM microphone is automatically muted, when the PMM is removed from the base unit.
